(19) United States
(12) Patent Application Publication
(10) Pub. No.: US 2026/0308062 A1
(43) Pub. Date: Oct. 8, 2026

(54) Method of Forming a Binder Composition and Products Formed Therefrom

(71) Applicants: EStav Consulting L.L.C., Charlotte, NC (US); A.M.N (Natanya) Engineering and Consulting, LTD, Natanya (IL)

(72) Inventors: Eli Stav, Charlotte, NC (US); Nechemia Masuri, Natanya (IL)

(21) Appl. No.: 19/640,724

(22) Filed: Apr. 7, 2026

Related U.S. Application Data
(60) Provisional application No. 63/784,432, filed on Apr. 7, 2025.

(51) Int. Cl. C04B 28/02; C04B 7/12; C04B 24/10; C04B 41/45; C04B 41/52; C04B 103/00; C04B 103/40

(52) U.S. Cl. CPC C04B 28/02; C04B 7/12; C04B 24/10; C04B 41/4539; C04B 41/52; C04B 2103/0088; C04B 2103/408

(57) ABSTRACT

The present disclosure is directed to a binder composition and products formed therefrom. Further, the present disclosure is directed to a method of making such binder composition. Notably, the method may include applying a coating composition to a first binder composition having a temperature of about 70° C. or more when the coating composition is initially applied to the first binder composition. The coating composition may include a coating additive. The first binder composition may include a cement.

### RELATED APPLICATIONS

The present application is based upon and claims priority to U.S. Provisional Patent Application Ser. No. 63/784,432, having a filing date of Apr. 7, 2025, which is incorporated herein by reference in its entirety.

### BACKGROUND

Cementitious products are utilized in the construction industry for various applications. Generally, these cementitious products, such as cement boards and more generally cement compositions, may be formed from a cement slurry including a mixture of one or more binders, water, and other conventional additives. Notably, the water to binder ratio is an influential parameter that contributes to the fluidity of the cement slurry, the density and the strength of the cement core, and the hydration of one or more binders in the cement slurry. In general, excess water is often utilized to provide effective hydration of the binder and/or to ensure acceptable cement slurry fluidity. Notably, the utilization of excess water may, for instance, reduce the strength of a cement board.

As a result, there is a need to provide an improved, sustainably manufactured cement board that utilizes a reduced amount of water in the formation of the cement slurry and cement core. Further, there is a need to provide improved, sustainably manufactured products (e.g., cementitious products) that incorporate a binder composition.

### SUMMARY OF THE INVENTION

Aspects and advantages of the invention will be set forth in part in the following description, or may be obvious from the description, or may be learned through practice of the invention.

In accordance with one embodiment of the present invention, a method of making a cement board is disclosed. The method comprises: subjecting a binder to a thermal treatment to form a first binder composition; and applying a coating composition to the first binder composition to form a second binder composition, the coating composition comprising water and a coating additive, the first binder composition having a temperature of about 70° C. or more when the coating composition is initially applied to the first binder composition.

In some implementations, the binder comprises a cement, the cement comprising Portland cement, magnesia cement, alumina cement, calcium sulphoaluminate cement, slag cement, super sulfate cement, or a mixture thereof.

In some implementations, the binder comprises fine calcium carbonate.

In some implementations, the binder comprises a pozzolan material, the pozzolan material comprising blast furnace slag, metakaolin, silica fume, microsilica, fly ash, or a mixture thereof.

In some implementations, the coating additive comprises a carbohydrate.

In some implementations, the coating additive comprises a sugar.

In some implementations, the coating additive comprises dextrose.

In some implementations, the coating additive comprises a dispersant.

In some implementations, the dispersant comprises a sulfonate.

In some implementations, the dispersant comprises a carboxylate.

In some implementations, the coating composition comprises a coating additive and a dispersant.

In some implementations, the coating additive may be water-soluble.

In some implementations, the coating additive may be water-dispersible.

In some implementations, the coating additive is present on the second binder composition in an amount of about 0.01 wt. % to about 5 wt. % based on the weight of the binder of the second binder composition.

In some implementations, the first binder composition has a temperature of about 80° C. or more when the coating composition is initially applied to the first binder composition.

In some implementations, the first binder composition has a temperature of about 100° C. or more when the coating composition is initially applied to the first binder composition.

In some implementations, the first binder composition has a temperature of about 800° C. or less when the coating composition is initially applied to the first binder composition.

In some implementations, the first binder composition has a temperature of about 200° C. or less when the coating composition is initially applied to the first binder composition.

In some implementations, the coating formed from the coating composition covers about 0.1% or more of the surface area of the binder of the second binder composition.

In some implementations, the method further comprises conditioning the second binder composition.

In some implementations, the method further comprises applying a second coating composition to the second binder composition.

In some implementations, the method further comprises heating and/or reheating the first binder composition before the coating composition is applied to the first binder composition.

In some implementations, the coating composition is in the form of an emulsion.

In some implementations, the coating composition is in the form of a dispersion.

In some implementations, the binder comprises a cement, and the first binder composition has a temperature of about 400° C. or less when the coating composition is initially applied to the first binder composition.

In some implementations, at least a portion of the coating composition vaporizes after contacting the first binder composition.

In some implementations, 10 wt. % or more of the coating composition vaporizes after contacting the first binder composition.

In some implementations, the coating additive is present on the second binder composition in an amount of about 0.01 wt. % to about 5 wt. % based on the weight of the binder of the second binder composition.

In accordance with one aspect of the present disclosure, a method of making a cement board is disclosed. The method comprises: providing a first facing material; depositing a cement slurry comprising the second binder composition and water onto the first facing material; and providing a second facing material on the cement slurry.

In some implementations, the weight ratio of the water to the total amount of binders in the cement slurry is about 0.8 or less.

A binder composition in accordance with the present disclosure may be included in one or more products, such as one or more binder-comprising products.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a method of forming a binder composition, the binder composition itself, and products formed therefrom. Further, the present disclosure is directed to a method of forming a cement board and the resulting cement board. In particular, the method may include applying a coating composition to one or more components of a cement board and/or a cement slurry, such as a binder. Notably, the method may include applying a coating composition to one or more components of a cement slurry that forms a cement core of a cement board. In general, the cement core may include one or more binders, a coating composition and/or one or more components thereof, and may include other optional additives.

Additionally, the present disclosure is directed to other products or compositions incorporating a binder composition, such as gypsum cement, concrete, masonry, blocks, precast components, and any other products that may include a binder composition. In this respect, the present disclosure is also directed to products and compositions comprising an at least partially coated binder composition, which may be referred to herein as a second binder composition.

Notably, the method of the present disclosure may decrease the water demand of various cement products and/or compositions. In general, a cement board or other product formed in accordance with the present disclosure may be formed in a more sustainable or environmentally friendly manner as compared to the formation of traditional cement boards. For instance, a cement board formed in accordance with the present disclosure may utilize less water in the formation of the cement slurry as compared to a traditional cement board. Further, during the production of a cement board, the cement board generally undergoes a drying process. Notably, a reduction in the water usage may decrease the energy utilized to dry a cement board. In this respect, the energy utilized in the process of forming a cement board in accordance with the present disclosure may be lower than the energy utilized in the process of forming a traditional cement board.

It should be understood that throughout the entirety of this specification, each numerical value (e.g., weight percentage) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that, unless stated otherwise, any standard listed herein (e.g., ASTM) is the most recent version available as of the latest revision year. Further, it should be understood that throughout the entirety of this specification, the term “and/or” refers to one or all of the listed components or a combination of any two or more of the listed components. Notably, some aspects of the present disclosure may omit one or more of the features disclosed herein.

Generally, the process of forming a product that incorporates a binder composition (e.g., a cement board, gypsum cement, concrete, masonry, blocks, precast components) includes obtaining or procuring one or more binders. The one or more binders may be ground or milled into smaller binder particles. In general, a binder refers to a material that can set on hydration. Such a material may also be generally referred to as a hydraulic cement. Notably, the one or more binders may include one or more cements, one or more pozzolan materials, gypsum, or a combination thereof.

In some aspects, the cement may include Portland cement, magnesia cement, alumina cement (e.g., calcium aluminate cement), calcium sulphoaluminate (CSA) cement, or a mixture thereof. In one embodiment, the cement may include at least Portland cement. In another embodiment, the cement may include at least alumina cement. In one embodiment, the binder may include at least Portland cement and alumina cement.

In some aspects, the pozzolan material may include fly ash, blast furnace slag, diatomaceous earth, metakaolin, silica fume, microsilica, or a combination thereof. In one embodiment, the pozzolan material may include fly ash. In another embodiment, the pozzolan material may include blast furnace slag. In a further embodiment, the pozzolan material may include metakaolin. In another further embodiment, the pozzolan material may include silica fume. In another further embodiment, the pozzolan material may include diatomaceous earth. In an even further embodiment, the pozzolan material may include microsilica.

Notably, one or more binders (e.g., a cement) may be mixed and/or subjected to a thermal treatment to form a first binder composition comprising a binder (e.g., a cement). The thermal treatment may remove other, unpreferred components from one or more binders of the first binder composition. The thermal treatment may be performed via a heating device such as a kiln (e.g., a rotary kiln), a fluidized bed, a Calcidyne, an impact mill, a rotary mill, a kettle, an IR heating station, and/or an autoclave. Notably, the thermal treatment may use or involve hot air or gas. In general, the thermal treatment may be performed via direct heating and/or indirect heating. Generally, the thermal treatment may be performed in a pressurized system. It should be understood that any of the heating devices disclosed herein may be used to heat one or more binders to form a first binder composition. Notably, a heating device may be configured to heat one or more binders to a temperature of about 100° C. or more, such as about 150° C. or more, such as about 200° C. or more.

In some aspects, the binder may be heated to a temperature from about 1000° C. to about 1600° C., including all increments of 1° C. therebetween.

Generally, a binder or mixture of binders may be heated to a temperature of about 1000° C. or more, such as about 1100° C. or more, such as about 1200° C. or more, such as about 1300° C. or more, such as about 1400° C. or more, such as about 1500° C. or more. In general, a binder or mixture of binders may be heated to a temperature of about 1600° C. or less, such as about 1500° C. or less, such as about 1400° C. or less, such as about 1300° C. or less, such as about 1200° C. or less, such as about 1100° C. or less. It should be understood that any of the aforementioned temperatures, including any ranges thereof, may be the temperature of the heating device.

After leaving the heating device, one or more coating compositions may be applied to the first binder composition to form a second binder composition. A portion of the second binder composition may be at least partially coated with a coating composition and/or a component thereof (e.g., coating additive). Notably, one or more components of a coating composition, such as any of the coating composition components (e.g., one or more coating additives) disclosed herein, may form a coating on one or more binders (e.g., a cement) of the first binder composition. The coating may cover about 0.1% or more of the surface area (e.g., BET surface area) of a binder (e.g., the cement) of the first binder composition, such as about 0.5% or more, such as about 1% or more, such as about 5% or more, such as about 10% or more, such as about 30% or more, such as about 50% or more.

In some aspects, a first binder composition may include a binder in an amount from about 50 wt. % to about 100 wt. %, including all increments of 0.01 wt. % therebetween.

Generally, a first binder composition may include a binder in an amount of about 50 wt. % or more, such as about 60 wt. % or more, such as about 70 wt. % or more, such as about 80 wt. % or more, such as about 90 wt. % or more, such as about 95 wt. % or more. In general, a first binder composition may include a binder in an amount of about 100 wt. % or less, such as about 90 wt. % or less, such as about 80 wt. % or less, such as about 70 wt. % or less, such as about 60 wt. % or less.

In some aspects, a second binder composition may include a binder in an amount from about 50 wt. % to about 100 wt. %, including all increments of 0.01 wt. % therebetween.

Generally, a second binder composition may include a binder in an amount of about 50 wt. % or more, such as about 60 wt. % or more, such as about 70 wt. % or more, such as about 80 wt. % or more, such as about 90 wt. % or more, such as about 95 wt. % or more. In general, a second binder composition may include a binder in an amount of about 100 wt. % or less, such as about 90 wt. % or less, such as about 80 wt. % or less, such as about 70 wt. % or less, such as about 60 wt. % or less.

After leaving the heating device, a first binder composition may be transported or conveyed, such as via a screw conveyor, a conveyor belt, and/or a fluidized bed. Notably, the first binder composition may have a coating composition applied thereon while the first binder composition is being transported or conveyed. In some aspects, the first binder composition may be agitated or vibrated while being transported or conveyed. In some aspects, the first binder composition may be agitated or vibrated while a coating composition is applied to the first binder composition. In general, a series of roller bars under the surface of a conveyor may agitate or vibrate the first binder composition while the coating composition is applied to the first binder composition. In general, a series of roller bars beneath the conveyor surface, pneumatic conveying, fluidized air bed, an air gun, a screw conveyor, or other devices and/or methods that increase the exposed surface area of the binder composition may agitate or vibrate the first binder composition during the application of the coating composition.

In some aspects, a coating composition may be applied to a first binder composition in an amount of about 0.01 wt. % to about 50 wt. %, including all increments of 1 wt. % therebetween, by weight of a binder (e.g., cement) of the first binder composition.

Generally, a coating composition may be applied to a first binder composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 15 wt. % or more, such as about 20 wt. % or more, such as about 30 wt. % or more, such as about 40 wt. % or more by weight of a binder of the first binder composition. A coating composition may be applied to a first binder composition in an amount of about 50 wt. % or less, such as about 40 wt. % or less, such as about 30 wt. % or less, such as about 20 wt. % or less, such as about 15 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less by weight of a binder of the first binder composition.

In some aspects, a coating composition may be applied to a first binder composition having a temperature of from about 40° C. to about 200° C., including all increments of 1° C. therebetween. A coating composition may be applied to a first binder composition having a temperature from about 80° C. to about 400° C., such as about 80° C. to about 200° C., such as about 80° C. to about 120° C. It should be understood that the aforementioned temperatures refer to the temperature of the first binder composition.

Generally, after leaving the heating device, a coating composition may be applied to a first binder composition having a temperature of about 40° C. or more, such as about 50° C. or more, such as about 60° C. or more, such as about 70° C. or more, such as about 80° C. or more, such as about 90° C. or more, such as about 100° C. or more, such as about 110° C. or more, such as about 120° C. or more, such as about 130° C. or more, such as about 140° C. or more, such as about 150° C. or more, such as about 160° C. or more, such as about 170° C. or more, such as about 180° C. or more, such as about 190° C. or more. In general, after leaving the heating device, a coating composition may be applied to a first binder composition having a temperature of about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less. It should be understood that any of the aforementioned temperatures, including any ranges thereof, may be the temperature of a first binder composition when the coating composition is initially applied to the first binder composition.

In some aspects, the first binder composition may be heated and/or reheated before a coating composition is applied to the first binder composition. The first binder composition may be heated and/or reheated to a temperature of from about 40° C. to about 200° C., including all increments of 1° C. therebetween, such as about 60° C. to about 200° C., such as about 80° C. to about 150° C., such as about 80° C. to about 120° C.

Notably, a coating composition formed in accordance with the present disclosure may include water, one or more coating additives, one or more dispersants (e.g., any of the dispersants disclosed herein), or a combination thereof. The one or more coating additives and/or one or more dispersants may be in the form of a liquid and/or a solid. The one or more coating additives may include one or more water-soluble additives and/or one or more water-dispersible additives. The one or more coating additives may be soluble in water, partially soluble in water, or insoluble in water. A coating additive may be or include a dispersant. The one or more dispersants may be water-soluble. Generally, the coating composition may be in the form of a dispersion or an emulsion. As used herein, the term “dispersion” refers to a liquid having solid particles dispersed therein.

In some aspects, one or more coating additives may include one or more carbohydrates. Notably, one or more carbohydrates may include one or more sugars, such as one or more monosaccharides. In some aspects, one or more carbohydrates may include dextrose. In some aspects, the one or more coating additives may include a synthetic polymer. For instance, the one or more coating additives may include polyethylene glycol.

In some aspects, one or more dispersants may include naphthalene sulfonate and/or a lignosulfonate. Notably, a lignosulfonate may provide a similar water reduction effect as naphthalene sulfonate using the above method of application of the coating composition to the first binder composition. When a lignosulfonate is added to a mixer with a binder, such as during the formation of a cement slurry, it may not have the same water reduction effect compared to the above method of application of the coating composition to the first binder composition. The use of a lignosulfonate may make the process of the present disclosure more environmentally friendly in that the use of formaldehyde may be avoided or reduced.

In some aspects, one or more coating additives may be present in a coating composition in an amount of from about 0.01 wt. % to about 99.99 wt. %, including all increments of 0.01 wt. % therebetween. In some aspects, one or more coating additives may be present in a coating composition in an amount from about 0.01 wt. % to about 50 wt. %, such as about 5 wt. % to about 40 wt. %, such as about 10 wt. % to about 40 wt. %.

Generally, one or more coating additives may be present in a coating composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 20 wt. % or more, such as about 30 wt. % or more, such as about 40 wt. % or more, such as about 50 wt. % or more. In general, one or more coating additives may be present in a coating composition in an amount of about 100 wt. % or less, such as about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

In some aspects, one or more dispersants, such as any of the dispersants disclosed herein, may be present in a coating composition in an amount of from about 0.01 wt. % to about 99.99 wt. %, including all increments of 0.01 wt. % therebetween.

Generally, one or more dispersants may be present in a coating composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 20 wt. % or more, such as about 30 wt. % or more, such as about 40 wt. % or more, such as about 50 wt. % or more. In general, one or more dispersants may be present in a coating composition in an amount of about 100 wt. % or less, such as about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

In some aspects, one or more dispersants may include one or more sulfonates, one or more carboxylates, one or more sulfates, one or more phosphates, or a combination thereof.

In some aspects, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In some aspects, the dispersant may include a carboxylate, such as a carboxylate ether, and in particular a polycarboxylate ether or a carboxylate ester, and in particular a polycarboxylate ester.

In some aspects, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In some aspects, a coating composition may include water. In some aspects, water may be present in a coating composition in an amount of from about 0.01 wt. % to about 99.99 wt. %, including all increments of 0.01 wt. % therebetween. For instance, water may be present in a coating composition in an amount from about 50 wt. % to about 100 wt. %, such as from about 60 wt. % to about 100 wt. %.

Generally, water may be present in a coating composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 20 wt. % or more, such as about 30 wt. % or more, such as about 40 wt. % or more, such as about 50 wt. % or more. In general, water may be present in a coating composition in an amount of about 100 wt. % or less, such as about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

Generally, a coating composition and/or one or more components thereof (e.g., a coating additive) may undergo shearing in a continuous or batch shear mixer, such as a Quadro® Liquids high shear mixer, pin mixer, or an Axiflow® high shear mixer, at any time of the process disclosed herein, including during, before, and/or after any of the process steps disclosed herein. After the shear mixer has mixed a coating composition and/or one or more components thereof, the resulting coating composition, which may be in the form of a dispersion or an emulsion, may be applied (e.g., sprayed) to a first binder composition.

In some aspects, the coating composition and/or one or more components thereof may be sheared at a shear rate of from about 5000 rpm to about 22000 rpm, including all increments of 1 rpm therebetween. In general, a coating composition and/or one or more components thereof may be sheared at a shear rate of about 5000 rpm or more, such as about 5500 rpm or more, such as about 6000 rpm or more, such as about 6500 rpm or more, such as about 7000 rpm or more, such as about 7500 rpm or more, such as about 8000 rpm or more, such as about 8500 rpm or more, such as about 9000 rpm or more, such as about 9500 rpm or more, such as about 10000 rpm or more, such as about 11000 rpm or more, such as about 12000 rpm or more, such as about 13000 rpm or more, such as about 14000 rpm or more, such as about 15000 rpm or more, such as about 18000 rpm or more. Generally, a coating composition and/or one or more components thereof may be sheared at a shear rate of about 22000 rpm or less, such as about 20000 rpm or less, such as about 18000 rpm or less, such as about 15000 rpm or less, such as about 14000 rpm or less, such as about 13000 rpm or less, such as about 12000 rpm or less, such as about 11000 rpm or less, such as about 10000 rpm or less, such as about 9500 rpm or less, such as about 9000 rpm or less, such as about 8500 rpm or less, such as about 8000 rpm or less, such as about 7500 rpm or less, such as about 7000 rpm or less, such as about 6500 rpm or less, such as about 6000 rpm or less, such as about 5500 rpm or less.

In general, a coating composition and/or one or more components thereof may be milled (e.g., ball-milled). As used herein, “milled” is synonymous with “ground”. Notably, the milling of a coating composition and/or one or more components thereof may decrease the average particle size of one or more components of a coating composition. It should be understood that any of the components of the coating composition may be milled together or may be milled separately. When milled separately, the components of the coating composition may be combined or mixed before being applied to a first binder composition. In general, a coating composition and/or one or more components thereof may be milled (e.g., ball-milled) before, after, and/or during any of the process steps disclosed herein.

As previously disclosed, a coating composition and/or one or more components thereof may be ball-milled. However, it should be understood that a coating composition and/or one or more components thereof may be milled by other equipment such as, for instance, an attritor, a vibration mill, an impact mill, a planetary ball mill, a jet mill, and the like.

In general, a coating composition may be applied by spraying (e.g., misting), curtain coating, dripping, or a combination thereof. Generally, if the coating composition is applied via spraying, the intensity and/or angle of the spraying and the distance of the spraying mechanism to a first binder composition may affect the depth of penetration of the coating composition in the first binder composition.

Notably, the inventors of the present disclosure have discovered that applying a coating composition to a first binder composition may reduce the amount of water utilized to form a cement board. In this respect, the coating provided by the coating composition may delay the reaction of water with a binder (e.g., cement) of the first binder composition. The delayed reaction of water with the binder retards the hydration reaction and may allow for a more even and/or homogenous reaction of the water with the binder of the first binder composition. Further, the coating provided by the coating composition may aid in keeping the slurry mixer clean during operation, which may reduce downtime.

As previously disclosed herein, the application of a coating composition may occur while the first binder composition has an elevated temperature. This application method may be particularly advantageous in that the water of a coating composition may be vaporized or evaporated, such as via flash evaporation, upon contact, or shortly after contact, with a binder, while one or more components (e.g., coating additive) of the coating composition form a coating on the binder. Notably, the use of elevated temperatures may be particularly advantageous in that the vaporization of the water may reduce or prevent the formation of lumps in the binder and/or the hydration of the binder. The temperature of the first binder composition to which the coating composition is applied may be adjusted to optimize the amount of binder coated by the coating composition while also reducing the conversion of binder to its hydrated form via the reaction of the water of the coating composition with the binder. Notably, the temperature of the first binder composition to which the coating composition is applied may be adjusted by air-cooling, which may involve one or more blowers or fans.

Notably, as previously disclosed herein, after a coating composition is applied to a first binder composition, one or more components (e.g., water) of the coating composition may vaporize. A coating additive may remain on the binder composition after one or more components of the coating composition vaporize. The coating additive may be present as crystallites, particles, deposits, residues, domains, and the like on the surface of the binder of the second binder composition.

In some aspects, the temperature of the coating composition may be adjusted to optimize the amount of binder coated by the coating composition while also reducing the conversion of binder to its hydrated form via the reaction of the water of the coating composition with the binder of the first binder composition. For instance, the coating composition may have a temperature from about 15° C. to about 110° C., including all increments of 1° C. therebetween.

In general, when applied to the first binder composition, the coating composition may have a temperature of about 15° C. or more, such as about 30° C. or more, such as about 50° C. or more, such as about 80° C. or more, such as about 100° C. or more. When applied to the first binder composition, the coating composition may have a temperature of about 110° C. or less, such as about 100° C. or less, such as about 80° C. or less, such as about 50° C. or less, such as about 30° C. or less.

In some aspects, one or more coating additives may be present on the second binder composition in an amount of about 0.01 wt. % to about 5 wt. %, including all increments of 0.01 wt. % therebetween, by weight of a binder of the second binder composition.

Generally, one or more coating additives may be present on the second binder composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more by weight of a binder of the second binder composition. One or more coating additives may be present on the second binder composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less by weight of a binder of the second binder composition.

In some aspects, a dispersant may be present on the second binder composition in an amount of about 0.01 wt. % to about 5 wt. %, including all increments of 0.01 wt. % therebetween, by weight of a binder of the second binder composition.

Generally, a dispersant may be present on the second binder composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more by weight of a binder of the second binder composition. A dispersant may be present on the second binder composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less by weight of a binder of the second binder composition.

In general, a binder composition may have two or more coating compositions applied thereto sequentially before, during, and/or after any of the process steps disclosed herein. Notably, a first coating composition may be applied to a first binder composition followed by a second coating composition being applied to the second binder composition. Any coating composition (e.g., first coating composition, second coating composition, third coating composition) may have any of the properties and/or characteristics of a coating composition as disclosed herein. Notably, one or more coating compositions (e.g., first coating composition) may be different from one or more other coating compositions (e.g., second coating composition). For instance, a first coating composition may include a carbohydrate, and a second coating composition may include a dispersant. Generally, a binder composition may be coated with two or more coating compositions before, during, and/or after any of the process steps disclosed herein.

After the application of a coating composition to a first binder composition to form a second binder composition, the second binder composition may be conditioned. Notably, the conditioning of a second binder composition may cool the second binder composition. The second binder composition may be conditioned by a conditioning device such as a mixer (e.g., rotary mixer), a mill, or a fluidized bed, in a continuous or batch process. In some aspects, the second binder composition may be air-cooled, which may involve one or more blowers or fans.

In some aspects, a second binder composition may be conditioned by utilizing a mixer to aerate and/or cool the second binder composition. Such mixers generally range in size and height, but an example of such a mixer used can have a diameter that falls within the range of about 12 inches to about 24 inches. Notably, the mixer may be equipped with a mechanism to introduce cold air into the mixer. For instance, the mixer may include one or more vortex tubes and/or one or more air nozzles.

In some aspects, the second binder composition may be heated and/or reheated before being included or added to a cement slurry or a mixer including components of the cement slurry.

In some aspects, a second binder composition may be added to the cement slurry and/or a mixer including components of the cement slurry while the second binder composition has a temperature of about 10° C. or more, such as about 15° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more. In some aspects, a second binder composition may be added to the cement slurry and/or a mixer including components of the cement slurry while the second binder composition has a temperature of about 110° C. or less, such as about 100° C. or less, such as about 90° C. or less, such as about 80° C. or less, such as about 70° C. or less, such as about 60° C. or less, such as about 50° C. or less, such as about 40° C. or less, such as about 30° C. or less, such as about 20° C. or less.

Generally, the present disclosure is also directed to a method of making a cement board. The method may include a step of combining water and at least one binder. The method may include a step of combining water and a second binder composition and/or one or more components (e.g., coating additive) thereof. In general, the method may include combining any of the additives disclosed herein to form the slurry. Notably, the second binder composition and/or one or more components thereof may be combined with other components to form the slurry. In this respect, the slurry may include the second binder composition and/or one or more components thereof.

The manner in which the additives are combined is not necessarily limited. For instance, the slurry can be made using any method or device generally known in the art. In particular, the components of the slurry can be mixed or combined using any method or device generally known in the art. For instance, the components of the slurry may be combined in any type of device, such as a mixer, and in particular a paddle mixer or the like. In addition, the device, such as the mixer, may operate as a batch process or as a continuous process.

As indicated above, the facing material may be provided on either or both sides of the core. In this regard, in one embodiment, the facing material (e.g., a first facing material) may be provided prior to deposition of the slurry. For instance, the method may include a step of depositing the slurry onto a facing material. For instance, the facing material may be conveyed on a conveyor system (i.e., a continuous system for continuous manufacture of cement board). In this regard, the slurry may be directly deposited onto the facing material. Next, after depositing the slurry, a facing material (e.g., a second facing material) may be provided on top of the slurry such that the slurry is sandwiched between the facing materials in order to form the cement board. When the facing materials are provided, they may be provided in such a manner as to provide a reinforced edge. For example, they may be provided such that the facing material covering one surface of the cement core wraps around a side edge so as to at least partially, and in one embodiment not completely, cover the facing material on the opposite side of the core. Without intending to be limited by theory, such wrap-around may augment the strength of the cement board at the border edge regions thereby allowing the board to retain sufficient structural integrity when a fastener, such as a screw or nail, is installed near the edge.

As indicated above, in general, the present disclosure is directed to a method of making a cement board and the resulting cement board. The cement board includes a core, also referred to as a cement core. In general, the composition of the core is not necessarily limited and may be any core generally known in the art. Regardless, the core is typically made from a slurry.

The cement core also includes one or more binders. A binder of the cement core may be a binder of the second binder composition or may be the second binder composition. Notably, the binder of the second binder composition may be a cement. The present disclosure is not necessarily limited and may include binders generally known in the art. For instance, these may include, but are not limited to, a cement, a pozzolan material, gypsum, limestone (e.g., fine ground limestone), dolomite, or a mixture thereof. In particular, the binder may include a cement.

The cement may include any cement as generally known in the art. For instance, the cement may include, but is not limited to, Portland cement, magnesia cement, alumina cement (e.g., calcium aluminate cement), calcium sulphoaluminate cement, or a mixture thereof. In one embodiment, the cement may include at least Portland cement. In another embodiment, the cement may include at least alumina cement. In one embodiment, the binder includes at least two, such as at least three cements. For example, in one embodiment, the binder may include at least Portland cement and an alumina cement.

When the cement board includes Portland cement and alumina cement, they may be present within a certain weight ratio. For instance, the weight ratio of Portland cement to alumina cement may be 2 or more, such as 3 or more, such as 4 or more, such as 5 or more, such as 6 or more, such as 7 or more, such as 8 or more, such as 9 or more. The weight ratio may be 50 or less, such as 40 or less, such as 30 or less, such as 25 or less, such as 20 or less, such as 18 or less, such as 16 or less, such as 14 or less, such as 12 or less, such as 10 or less, such as 9 or less, such as 8 or less, such as 7 or less, such as 6 or less.

The pozzolan material may include any pozzolan material as generally known in the art. For instance, the pozzolan material may include, but is not limited to, fly ash, blast furnace slag, diatomaceous earth, metakaolin, silica fume, microsilica, or a mixture thereof. In one embodiment, the pozzolan material may include fly ash. In another embodiment, the pozzolan material may include blast furnace slag. In a further embodiment, the pozzolan material may include metakaolin. In another further embodiment, the pozzolan material may include silica fume. In another further embodiment, the pozzolan material may include diatomaceous earth. In an even further embodiment, the pozzolan material may include microsilica. In one embodiment, the binder includes at least two, such as at least three pozzolan materials.

In general, the binder may also include gypsum. When in the core, it may be present as uncalcined gypsum (i.e., calcium sulfate dihydrate). When added to the slurry, it may be added as calcined gypsum (i.e., calcium sulfate hemihydrate). Regardless, when utilized, it may be utilized in generally lower amounts. For example, the gypsum may be present in the core in an amount of 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.5 wt. % or less based on the weight of the core. In one embodiment, the gypsum may be present in an amount of 0 wt. % based on the weight of the core. In addition, it should be understood that the aforementioned weight percentages may be based on the weight of the cement board. Further, it should be understood that the aforementioned weight percentages may also apply to the amount of the gypsum based on the weight of the slurry when discussed in the context of the cement slurry in making the cement board.

In general, the cement(s) may be present in the core in an amount of 1 wt. % or more, such as 5 wt. % or more, such as 10 wt. % or more, such as 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more based on the weight of the core. The cement(s) may be present in the core in an amount of less than 100 wt. %, such as 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less, such as 15 wt. % or less based on the weight of the core. In addition, it should be understood that the aforementioned weight percentages may also apply to the amount of the cement(s) based on the weight of the cement board. Further, it should be understood that the aforementioned weight percentages may also apply to the amount of the cement(s) based on the weight of the slurry when discussed in the context of the cement slurry in making the cement board. In addition, the aforementioned percentages may also apply to a particular species of cement.

In general, the pozzolan material(s) may be present in the core in an amount of 0 wt. % or more, such as 5 wt. % or more, such as 10 wt. % or more, such as 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more based on the weight of the core. The pozzolan material(s) may be present in the core in an amount of less than 100 wt. %, such as 90 wt. % or less, such as 85 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less based on the weight of the core. In addition, it should be understood that the aforementioned weight percentages may also apply to the amount of the pozzolan material(s) based on the weight of the cement board. Further, it should be understood that the aforementioned weight percentages may also apply to the amount of the pozzolan material(s) based on the weight of the slurry when discussed in the context of the cement slurry in making the cement board. In addition, the aforementioned percentages may also apply to a particular species of pozzolan material.

In other embodiments, the cement core may include a relatively low amount of pozzolan material(s). For instance, the pozzolan material(s) may be present in an amount of 20 wt. % or less, such as 18 wt. % or less, such as 16 wt. % or less, such as 18 wt. % or less, such as 14 wt. % or less, such as 12 wt. % or less, such as 10 wt. % or less, such as 8 wt. % or less, such as 6 wt. % or less, such as 4 wt. % or less, such as 2 wt. % or less, such as 1 wt. % or less, such as 0.5 wt. % or less based on the weight of the core. The pozzolan material(s) may be present in an amount of 0 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more based on the weight of the core. In addition, it should be understood that the aforementioned weight percentages may also apply to the amount of the pozzolan material(s) based on the weight of the cement board. Further, it should be understood that the aforementioned weight percentages may also apply to the amount of the pozzolan material(s) based on the weight of the slurry when discussed in the context of the cement slurry in making the cement board.

In one particular embodiment, the fly ash may be present in a certain amount. For instance, the fly ash may be present in an amount of 20 wt. % or less, such as 18 wt. % or less, such as 16 wt. % or less, such as 18 wt. % or less, such as 14 wt. % or less, such as 12 wt. % or less, such as 10 wt. % or less, such as 8 wt. % or less, such as 6 wt. % or less, such as 4 wt. % or less, such as 2 wt. % or less, such as 1 wt. % or less, such as 0.5 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less, such as about 0 wt. % based on the weight of the core. The fly ash may be present in an amount of 0 wt. % or more. For example, if present, the fly ash may be present in an amount of 0.1 wt. % or more, such as 0.2 wt. % or more, such as 0.5 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more based on the weight of the core. In addition, it should be understood that the aforementioned weight percentages may also apply to the amount of the fly ash based on the weight of the cement board. Further, it should be understood that the aforementioned weight percentages may also apply to the amount of the fly ash based on the weight of the slurry when discussed in the context of the cement slurry in making the cement board.

In one embodiment, the binder may include a combination of a cement and a pozzolan material. For instance, the weight ratio of the total weight of the pozzolan materials to the total weight of the cement may be 0 or more, such as 0.01 or more, such as 0.1 or more, such as 0.1 or more, such as 0.2 or more, such as 0.5 or more, such as 0.8 or more, such as 1 or more, such as 1.5 or more, such as 2 or more, such as 2.5 or more, such as 3 or more, such as 4 or more, such as 5 or more. The weight ratio may be 10 or less, such as 8 or less, such as 6 or less, such as 5 or less, such as 4 or less, such as 3 or less, such as 2.5 or less, such as 2 or less, such as 1.5 or less, such as 1 or less, such as 0.5 or less, such as 0.4 or less.

In particular, the binder may include a combination of a cement and a fly ash. For instance, the weight ratio of the total weight of the fly ash to the total weight of the cement may be 0 or more, such as 0.01 or more, such as 0.1 or more, such as 0.2 or more, such as 0.5 or more, such as 0.8 or more, such as 1 or more. The weight ratio may be 1 or less, such as 0.5 or less, such as 0.4 or less.

In general, the binder(s) may be present in the core in an amount of 15 wt. % or more, such as 20 wt. % or more, such as 25 wt. % or more, such as 30 wt. % or more, 35 wt. % or more, such as 40 wt. % or more, such as 45 wt. % or more, such as 50 wt. % or more, such as 55 wt. % or more, such as 60 wt. % or more, such as 65 wt. % or more based on the weight of the core. The binder(s) may be present in the core in an amount of less than 100 wt. %, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less based on the weight of the core. In addition, it should be understood that the aforementioned weight percentages may also apply to the amount of the binder(s) based on the weight of the cement board. Further, it should be understood that the aforementioned weight percentages may also apply to the amount of the binder(s) based on the weight of the slurry when discussed in the context of the cement slurry in making the cement board.

The cement core may also include aggregates. For instance, the aggregates may include normal weight aggregates, lightweight aggregates, or a mixture thereof. In one embodiment, the cement core includes normal weight aggregates. In a further embodiment, the cement core includes lightweight aggregates. In an even further embodiment, the cement core includes a mixture of normal weight aggregates and lightweight aggregates. However, in addition to the above, it should be understood that the aggregates may also include heavy weight aggregates.

In general, normal weight aggregate may have a density of 1,100 kg/m³ or more, such as 1,300 kg/m³ or more, such as 1,500 kg/m³ or more to 2,100 kg/m³ or less, such as 2,000 kg/m³ or less, such as 1,800 kg/m³ or less, such as 1,600 kg/m³ or less. Meanwhile, lightweight aggregate may have a density of less than 1,100 kg/m³, such as 1,000 kg/m³ or less, such as 900 kg/m³ or less, such as 800 kg/m³ or less, such as 700 kg/m³ or less, such as 600 kg/m³ or less. In addition, a heavyweight aggregate may have a density of greater than 2,100 kg/m³.

In general, the normal weight aggregate may include any normal weight aggregate as generally known in the art. For instance, the normal weight aggregate may include, but is not limited to, sand, stone (e.g., crushed stone), limestone, shale, clay, recycled concrete, granite or other minerals, and the like, or a mixture thereof. In one embodiment, the normal weight aggregate includes sand (e.g., mortar grade sand). In another embodiment, the normal weight aggregate includes stone. In a further embodiment, the normal weight aggregate includes limestone. In an even further embodiment, the normal weight aggregate includes granite. In one embodiment, the normal weight aggregate includes at least two, such as at least three, such as at least four normal weight aggregates.

In general, the lightweight aggregate may include a material having a cellular or internal porous microstructures. For instance, the lightweight aggregate may include, but is not limited to, expanded shale, clay (e.g., expanded clay), foamed slag, sintered fly ash, vermiculite (e.g., expanded vermiculite), perlite (e.g., expanded perlite), pumice (e.g., expanded pumice), expanded glass (e.g., expanded closed-cell glass beads), hollow spheres (e.g., ceramic hollow spheres, glass hollow spheres, plastic hollow spheres, geopolymer hollow spheres, fly ash hollow spheres, silicate hollow spheres, or a mixture there), and the like, or a mixture thereof. In one embodiment, the lightweight aggregate includes perlite, such as expanded perlite. In another embodiment, the lightweight aggregate includes expanded shale. In one embodiment, the lightweight aggregate includes at least two, such as at least three, such as at least four lightweight aggregates. As an example, the lightweight aggregate includes a combination of perlite, such as expanded perlite, and/or expanded shale in one embodiment.

As indicated above, in one embodiment, the lightweight aggregate includes perlite. For instance, the perlite may be an expanded perlite. The perlite may be a closed-cell perlite, such as a closed-cell expanded perlite. In general, the perlite may have a general spherical structure.

The perlite may be non-hydrophobic or hydrophobic. For instance, in one embodiment, the perlite may be non-hydrophobic. In another embodiment, the perlite may be hydrophobic. For instance, the perlite may be treated, in particular to render the perlite hydrophobic. The treatment may be a coating on the surface of the perlite. For example, the coating may be a silicone, a silane, fatty acid derivative, or a mixture thereof. The coating may be formed on the perlite using various means in the art, such as spraying, dipping, misting, etc. In addition, the material be provided as a solution, such as an emulsion, in order to form the coating. Without intending to be limited by theory, the coating may prevent or minimize the ability of the perlite to absorb water.

For instance, in one embodiment, the coating may be a silicone coating. The silicone coating may be a siloxane polymer. The siloxane polymer may be a polyalkylsiloxane, in particular a polydialkylsiloxane, a polyarylsiloxane, in particular a polydiarylsiloxane, or a mixture thereof. In general, the alkyl may be a methyl, an ethyl, a propyl, a butyl, a pentyl, a hexyl, a heptyl, an octyl, or a nonyl group. In this regard, the alkyl may be a C₁-C₉ alkyl group, a C₁-C₅ alkyl group, a C₁-C₃ alkyl group, or a C₁-C₂ alkyl group. In this regard, the siloxane polymer may be a polydimethylsiloxane. In addition, other siloxane polymers may include, but are not limited to, polydiethylsiloxane, polydipropylsiloxane, polydibutylsiloxane, polymethylethylsiloxane, polydiphenylsiloxane, etc.

In one embodiment, the coating may include a fatty acid derivative. Suitable fatty acids typically have a backbone carbon chain of from about 12 to about 60 carbon atoms. For example, the chain may have 12 or more, such as 14 or more, such as 16 or more, such as 18 or more, such as 20 or more carbon atoms. The chain may have 60 or less, such as 50 or less, such as 40 or less, such as 30 or less, such as 26 or less, such as 24 or less, such as 22 or less, such as 20 or less carbon atoms. The fatty acid may include, but is not limited to, myristic acid, palmitic acid, stearic acid, arachidonic acid, montanic acid, octadecanoic acid, parinaric acid, etc. The fatty acid may be saturated in one embodiment. In another embodiment, the fatty acid may be unsaturated.

Suitable derivatives include fatty acid esters, fatty alcohol esters, wax esters, fatty acid salts, fatty acid amides, etc. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide, and so forth. Also suitable are the metal salts of fatty acids. These salts may include an alkali metal, an alkaline earth metal, a transition metal, etc. In particular, these metals may include, but are not limited to calcium, zinc, magnesium, aluminum, etc. For example, in one embodiment, the fatty acid derivative may include a stearate, such as calcium stearate, zinc stearate, magnesium stearate, or a mixture thereof.

In one embodiment, the coating may include a silane, such as an organosilane. The organosilane may have the structure X—R—Si(OR′)₃ wherein X can be a non-hydrolysable organic moiety comprising an epoxy, amino, vinyl methacryloxy, or sulfido moiety; R can be an arylene or an alkylene; and OR′ can be a moiety that can be hydrolysable.

As indicated above, X can be a non-hydrolysable organic moiety comprising an epoxy, amino, vinyl methacryloxy, or sulfido moiety. In one embodiment, X may be a non-hydrolysable organic moiety comprising an epoxy. In another embodiment, X may be a non-hydrolysable organic moiety comprising an amino.

As indicated above, R can be an arylene or an alkylene chain. For instance, in one embodiment, R may be arylene, such as a C₅-C₁₀ arylene, such as a C₅-C₈ arylene, such as a C₅-C₆ arylene, such as a C₅ arylene or a C₆ arylene. In another embodiment, R may be an alkylene. For example, the alkylene may be a C₁-C₆ alkylene, such as a C₁-C₄ alkylene, such as a C₁-C₃ alkylene, such as a C₁-C₂ alkylene or a C₂-C₃ alkylene. In one embodiment, R may be ethylene. In another embodiment, R may be propylene.

As indicated above, OR′ can be a moiety that can be hydrolysable. For instance, the moiety may be an alkoxy group (e.g., methoxy, ethoxy, isoproxy, butoxy) or an acetoxy group. In one embodiment, the moiety may be an alkoxy group. For example, in one embodiment, the moiety may be methoxy.

The organosilane can be bifunctional, wherein each molecule exhibits at least two reactive binding sites. The organosilane may include, but is not limited to, an epoxy silane (e.g., γ-glycidyloxypropyltrimethoxysilane), a glycidyl ether alkoxysilane, a glycidylalkyl alkoxysilane, an amino silane, an alkoxysilane, an aminoalkoxysilane, an alkyl silane, a vinyl silane, an acryloyl or methacryloyl-functional alkoxysilane, a sulfane or polysulfane-functional alkoxysilane, a mercapto-functional alkoxysilane, or a mixture thereof. In one embodiment, the organosilane may be an epoxy silane. In another embodiment, the organosilane may be an alkoxysilane, such as a halogen (e.g., chloro-, fluoro-) functional alkoxysilane.

For example, the organosilane may include, but is not limited to, γ-glycidyloxypropyltrimethoxysilane; N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes; aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; gamma-glycidoxypropyltrimethoxysilanes; vinyltrichlorosilane; vinyltris(beta-methoxyethoxy) silane; vinyl tri ethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta-(aminoethyl)-r-aminopropyl-trimethoxysilane; N-beta-(aminoethyl)-r-aminopropylmethyldimethoxysilane; 3-aminopropyl-triethoxysilane; N-phenyl-r-aminopropyltrimethoxysilane; r-mercaptopropyltrimethoxysilane; r-chloropropyltrimethoxysilane; vinyltrichlorosilane; vinyltris(beta-methoxyethoxy) silane; vinyltrimethoxysilane; r-metacryloxypropyltrimethoxysilane; beta-(3,4 epoxycyclohexyl)-ethyltrimethoxysila; r-glycidoxypropyltrimethoxysilane; r-glycidoxypropylmethylidiethoxysilane; N-beta-(aminoethyl)-r-aminopropyltrimethoxysilane; N-beta-(aminoethyl)-r-aminopropylmethyldimethoxysilane; r-aminopropyltriethoxysilane; N-phenyl-r-aminopropyltrimethoxysilane; r-mercaptopropyltrimethoxysilane; r-chloropropyltrimethoxysilane; hydrogentrimethoxysilane, hydrogentriethoxysilane, tetramethoxysilane, tetraethoxysilane, methyltrimethoxysilane, methyltriethoxysilane, methyltripropoxysilane, ethyltrimethoxysilane, ethyltriethoxysilane, n-propyltrimethoxysilane, isopropyltrimethoxysilane, n-propyltriethoxysilane, isopropyltriethoxysilane, n-butyltrimethoxysilane, isobutyltrimethoxysilane, n-butyltriethoxysilane, isobutyltriethoxysilane, n-pentyltrimethoxysilane, isopentyltrimethoxysilane, n-pentyltriethoxysilane, isopentyltriethoxysilane, n-hexyltrimethoxysilane, isohexyltrimethoxysilane, n-octyltrimethoxysilane, isooctyltrimethoxysilane, n-octyltriethoxysilane, isooctyltriethoxysilane, hexadecyltrimethoxysilane, hexadecyltriethoxysilane, octadecyltrimethoxysilane, octadecyltriethoxysilane, dimethyldimethoxysilane, dimethyldiethoxysilane, n-butylmethyldimethoxysilane, isobutylmethyldimethoxysilane, n-butylmethyldiethoxysilane, isobutylmethyldiethoxysilane, cyclohexylmethyldimethoxysilane, diisopropyldimethoxysilane, diisobutyldimethoxysilane, isobutylisopropyldimethoxysilane, vinyltrimethoxysilane, vinyltriethoxysilane, vinylmethyldialkoxysilane, vinyltris(2-methoxyethoxysilane), 1-aminomethyltrimethoxysilane, 1-aminomethyltriethoxysilane, 2-aminoethyltrimethoxysilane, 2-aminoethyltriethoxysilane, 3-aminopropyltrimethoxysilane, 3-aminopropyltriethoxysilane, 3-aminoisobutyltrimethoxysilane, 3-aminoisobutyltriethoxysilane, N-(n-butyl)-3-aminopropyltrimethoxysilane, 3-aminopropylmethyldiethoxysilane, 3-ureidopropyltrimethoxysilane, 3-ureidopropyltriethoxysilane, N-aminoethyl-3-aminopropyltrimethoxysilane, N-aminoethyl-3-aminopropyltriethoxysilane, triamino-functional propyltrimethoxysilane, 3-(4,5-dihydroimidazolyl) propyltriethoxysilane, 3-glycidyloxypropyltrimethoxysilane, 3-glycidyloxypropyltriethoxysilane, tridecafluorooctyltriethoxysilane, tridecafluorooctyltrimethoxysilane, 3-chloropropyltriethoxysilane, acryloyloxypropyltrimethoxysilane, acryloyloxypropyltriethoxysilane, 3-methacryloyloxypropyltrimethoxysilane, 3-methacryloyloxypropyltriethoxysilane, 3-methacryloyloxyisobutyltrimethoxysilane, 3-methacryloyloxyisobutyltriethoxysilane, 3-methacryloyloxy-2-methylpropyltrimethoxysilane, 3-methacryloyloxy-2-methylpropyltriethoxysilane, 3-mercaptopropyltrimethoxysilane, 3-mercaptopropyltriethoxysilane, (triethoxysilylpropyl)tetrasulfane, bis(trimethoxysilylpropyl)tetrasulfane, bis(triethoxysilylpropyl)disulfane, bis(trimethoxysilylpropyl)disulfane, bis(triethoxysilylpropyl)sulfane, bis(trimethoxysilylpropyl)sulfane, bis(triethoxysilylpropyl)pentasulfane, bis(trimethoxysilylpropyl)pentasulfane, or a mixture thereof.

As indicated by the structure above, the organosilane may differ from the siloxane in that the organosilane may be a distinct compound, rather than an oligomer or polymer, whether a thermoset or thermoplastic. Meanwhile, the siloxane may be an oligomer or polymeric type material, in particular a thermoplastic or thermoset type material.

The coating may be present in an amount of 0.001 wt. % or more, such as 0.005 wt. % or more, such as 0.01 wt. % or more, such as 0.03 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more based on the total weight of the perlite with the coating. The coating may be present in an amount of 20 wt. % or less, such as 18 wt. % or less, such as 15 wt. % or less, such as 12 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.1 wt. % or less based on the total weight of the perlite with the coating. In a further embodiment, such aforementioned weight percentages may be for the coating based on the weight of the uncoated perlite.

The perlite may have a loose bulk density of 50 kg/m³ or more, such as 60 kg/m³ or more such as 70 kg/m³ or more, such as 80 kg/m³ or more, such as 90 kg/m³ or more, such as 100 kg/m³ or more, such as 110 kg/m³ or more, such as 120 kg/m³ or more, such as 130 kg/m³ or more, such as 140 kg/m³ or more. The perlite may have a loose bulk density of 200 kg/m³ or less, such as 190 kg/m³ or less, such as 180 kg/m³ or less, such as 170 kg/m³ or less, such as 160 kg/m³ or less, such as 150 kg/m³ or less, such as 140 kg/m³ or less, such as 130 kg/m³ or less, such as 120 kg/m³ or less, such as 110 kg/m³ or less, such as 100 kg/m³ or less.

The perlite may have a particular average particle size of 100 microns or more, such as 110 microns or more, such as 120 microns or more, such as 130 microns or more, such as 150 microns or more, such as 180 microns or more, such as 200 microns or more, such as 230 microns or more, such as 250 microns or more, such as 280 microns or more, such as 300 microns or more, such as 320 microns or more, such as 350 microns or more. The average particle size may be 600 microns or less, such as 580 microns or less, such as 550 microns or less, such as 530 microns or less, such as 500 microns or less, such as 470 microns or less, such as 450 microns or less, such as 430 microns or less, such as 410 microns or less, such as 400 microns or less, such as 390 microns or less, such as 370 microns or less, such as 350 microns or less.

The perlite may have a d98 of 150 microns or more, such as 160 microns or more, such as 170 microns or more, such as 180 microns or more, such as 190 microns or more, such as 200 microns or more, such as 210 microns or more, such as 230 microns or more, such as 250 microns or more, such as 270 microns or more, such as 290 microns or more, such as 300 microns or more, such as 320 microns or more, such as 340 microns or more, such as 350 microns or more. The perlite may have a d98 of 500 microns or less, such as 450 microns or less, such as 420 microns or less, such as 400 microns or less, such as 380 microns or less, such as 350 microns or less, such as 320 microns or less, such as 300 microns or less, such as 270 microns or less, such as 250 microns or less, such as 220 microns or less, such as 210 microns or less, such as 200 microns or less.

As indicated above, in one embodiment, the lightweight aggregate includes expanded shale. The expanded shale may have a particular particle size. For instance, the average particle size may be 100 mm or less, such as 9 mm or less, such as 8 mm or less, such as 7 mm or less, such as 6 mm or less, such as 5.5 mm or less, such as 5 mm or less, such as 4.5 mm or less, such as 4 mm or less, such as 3.5 mm or less, such as 3.2 mm or less, such as 3 mm or less, such as 2.8 mm or less, such as 2.5 mm or less, such as 2.2 mm or less, such as 2 mm or less, such as 1.8 mm or less, such as 1.6 mm or less, such as 1.4 mm or less, such as 1.2 mm or less, such as 1 mm or less, such as 0.9 mm or less, such as 0.8 mm or less, such as 0.7 mm or less, such as 0.6 mm or less, such as 0.5 mm or less, such as 0.4 mm or less. The average particle size may be 0.1 mm or more, such as 0.2 mm or more, such as 0.3 mm or more, such as 0.5 mm or more, such as 0.7 mm or more, such as 0.9 mm or more, such as 1 mm or more, such as 1.2 mm or more, such as 1.5 mm or more, such as 1.8 mm or more, such as 2 mm or more, such as 2.5 mm or more, such as 3 mm or more, such as 3.5 mm or more, such as 4 mm or more, such as 4.5 mm or more, such as 5 mm or more, such as 5.5 mm or more. In one embodiment, such aforementioned size may refer to the average longest dimension (e.g., diameter) of the expanded shale.

The expanded shale may also have a particular density. For instance, the density may be 75 pcf or less, such as 72 pcf or less, such as 70 pcf or less, such as 68 pcf or less, such as 66 pcf or less, such as 64 pcf or less, such as 62 pcf or less, such as 60 pcf or less, such as 58 pcf or less, such as 55 pcf or less, such as 53 pcf or less, such as 50 pcf or less, such as 47 pcf or less, such as 45 pcf or less, such as 42 pcf or less. The density may be 30 pcf or more, such as 33 pcf or more, such as 35 pcf or more, such as 38 pcf or more, such as 40 pcf or more, such as 43 pcf or more, such as 45 pcf or more, such as 48 pcf or more, such as 50 pcf or more, such as 53 pcf or more, such as 55 pcf or more, such as 58 pcf or more, such as 60 pcf or more.

In general, the aggregate(s) may be present in the core in an amount of 0.1 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 65 wt. % or more based on the weight of the core. The aggregate(s) may be present in the core in an amount of 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less based on the weight of the core. In addition, it should be understood that the aforementioned weight percentages may also apply to the amount of the aggregate(s) based on the weight of the cement board. Further, it should be understood that the aforementioned weight percentages may also apply to the amount of the aggregate(s) based on the weight of the slurry when discussed in the context of the cement slurry in making the cement board. In addition, the aforementioned percentages may also apply to a particular species of aggregate.

Furthermore, the normal weight aggregate(s) may be present in the core in an amount of 0.1 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 25 wt. % or more, such as 30 wt. % or more, such as 40 wt. % or more, such as 50 wt. % or more, such as 60 wt. % or more, such as 65 wt. % or more based on the weight of the core. The normal weight aggregate(s) may be present in the core in an amount of 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less based on the weight of the core. In addition, it should be understood that the aforementioned weight percentages may also apply to the amount of the normal weight aggregate(s) based on the weight of the cement board. Further, it should be understood that the aforementioned weight percentages may also apply to the amount of the normal weight aggregate(s) based on the weight of the slurry when discussed in the context of the cement slurry in making the cement board. In addition, the aforementioned percentages may also apply to a particular species of normal weight aggregate. For instance, the aforementioned weight percentages may apply to limestone in one embodiment. In another embodiment, the aforementioned weight percentages may apply to sand. In a further embodiment, the aforementioned weight percentages may apply to a combination of limestone and sand.

In addition, the lightweight aggregate(s) may be present in the core in an amount of 0.1 wt. % or more, such as 0.3 wt. % or more, such as 0.5 wt. % or more, such as 0.8 wt. % or more, such as 1 wt. % or more, such as 1.5 wt. % or more, such as 2 wt. % or more, such as 2.5 wt. % or more, such as 3 wt. % or more, such as 3.5 wt. % or more, such as 4 wt. % or more, such as 5 wt. % or more, such as 7 wt. % or more, such as 10 wt. % or more, such as 13 wt. % or more, such as 15 wt. % or more, such as 20 wt. % or more, such as 25 wt. % or more, such as 30 wt. % or more, such as 35 wt. % or more based on the weight of the core. The lightweight aggregate(s) may be present in the core in an amount of 50 wt. % or less, such as 45 wt. % or less, such as 40 wt. % or less, such as 35 wt. % or less, such as 30 wt. % or less, such as 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.6 wt. % or less, such as 0.4 wt. % or less, such as 0.3 wt. % or less based on the weight of the core. In addition, it should be understood that the aforementioned weight percentages may also apply to the amount of the lightweight aggregate(s) based on the weight of the cement board. Further, it should be understood that the aforementioned weight percentages may also apply to the amount of the lightweight aggregate(s) based on the weight of the slurry when discussed in the context of the cement slurry in making the cement board. In addition, the aforementioned percentages may also apply to a particular species of lightweight aggregate. For instance, the aforementioned weight percentages may apply to expanded shale in one embodiment. In another embodiment, the aforementioned weight percentages may apply to perlite. In a further embodiment, the aforementioned weight percentages may apply to a combination of expanded shale and perlite.

Furthermore, the aforementioned provides weight percentages for lightweight aggregates. However, in one embodiment, such percentages may be for lightweight aggregates not considered a combustible additive as defined herein.

Also, it should be understood that the aforementioned weight percentages may apply individually to the normal weight aggregates. Furthermore, it should be understood that the aforementioned weight percentages may apply individually to the lightweight aggregates. When both a normal weight aggregate and a lightweight aggregate are utilized, they may be present within a specific weight ratio. For instance, the weight ratio of the normal weight aggregate to the lightweight aggregate may be 0.01 or more, such as 0.05 or more, such as 0.1 or more, such as 0.2 or more, such as 0.3 or more, such as 0.5 or more, such as 1 or more, such as 3 or more, such as 5 or more, such as 8 or more, such as 10 or more, such as 11 or more, such as 12 or more, such as 13 or more, such as 15 or more. The weight ratio may be 100 or less, such as 90 or less, such as 80 or less, such as 70 or less, such as 60 or less, such as 50 or less, 40 or less, such as 30 or less, such as 25 or less, such as 20 or less, such as 18 or less, such as 15 or less, such as 13 or less, such as 10 or less, such as 8 or less, such as 6 or less, such as 4 or less, such as 2 or less, such as 1.5 or less, such as 1 or less, such as 0.8 or less, such as 0.6 or less, such as 0.5 or less, such as 0.4 or less, such as 0.3 or less, such as 0.2 or less. In one embodiment, such ratio may be based on all of the normal weight aggregates and lightweight aggregates.

As indicated herein, the cement board also includes a combustible additive. In general, a noncombustible additive may be one that passes the criteria in ASTM E136-19a (2022) when tested in accordance with either ASTM E136 or ASTM E2652. These materials may include those such as masonry, glass, steel, etc. The combustible additives as defined herein may be limited to combustible materials or combustible materials. As an example, limited combustible materials may be those that produce a heat value less than 3,500 BTU/lb when tested in accordance with NFPA 259 and/or when tested in accordance with ASTM E2965 at an incident heat flux of 75 kW/m² for 20 minutes, they meet the following conditions: a peak heat release rate doesn't exceed 150 kW/m² for more than 10 seconds and the total heat released is less than 8 MJ/m². In general, any combustible materials may be those not considered a noncombustible additive or a limited combustible material.

For instance, polystyrene (e.g., expanded polystyrene) may be considered a combustible additive. The polystyrene may include polystyrene beads, such as closed-cell polystyrene beads. Such polystyrene beads may be expanded polystyrene beads. The expanded polystyrene beads may have a particular size distribution. For instance, when taking into account all of the expanded beads, the average diameter of the expanded polystyrene beads may be 0.01 inches or more, such as 0.015 inches or more, such as 0.02 inches or more, such as 0.03 inches or more, such as 0.04 inches or more, such as 0.05 inches or more, such as 0.06 inches or more, such as 0.07 inches or more, such as 0.08 inches or more, such as 0.09 inches or more, such as 0.1 inches or more, such as 0.11 inches or more, such as 0.12 inches or more, such as 0.13 inches or more, such as 0.14 inches or more, such as 0.15 inches or more. The diameter may be 0.5 inches or less, such as 0.4 inches or less, such as 0.3 inches or less, such as 0.25 inches or less, such as 0.2 inches or less, such as 0.18 inches or less, such as 0.15 inches or less, such as 0.13 inches or less, such as 0.12 inches or less, such as 0.11 inches or less, such as 0.1 inches or less, such as 0.09 inches or less, such as 0.08 inches or less, such as 0.07 inches or less, such as 0.06 inches or less, such as 0.05 inches or less, such as 0.04 inches or less, such as 0.03 inches or less, such as 0.02 inches or less.

In one embodiment, the expanded polystyrene beads may have a unimodal size distribution wherein the average diameter is within the aforementioned range. In another embodiment, the expanded polystyrene beads may have a bimodal size distribution. For instance, a first set of expanded polystyrene beads may have an average diameter less than that of a second set of expanded polystyrene beads. The first set of expanded polystyrene beads may have an average diameter within the aforementioned range. Also, the second set of expanded polystyrene beads may also have an average diameter within the aforementioned range. Regardless, the first set has an average diameter less than the second set. Furthermore, the first set having an average diameter less than the second set may be present in an amount of 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more to less than 100 wt. %, such as 90 wt. % or less, such as 80 wt. % or less, such as 70 wt. % or less, such as 60 wt. % or less, such as 50 wt. % or less based on the total weight of the expanded polystyrene beads. In this regard, the balance may be occupied by the second set of expanded polystyrene beads.

The polystyrene beads and means for expanding are further described in U.S. Pat. No. 9,499,980, which is hereby incorporated by reference in its entirety.

The polystyrene may be utilized within a certain amount within the cement board as defined herein. In particular, the polystyrene is present in an amount of 1 wt. % or less, such as 0.8 wt. % or less, such as 0.6 wt. % or less, such as 0.5 wt. % or less, such as 0.45 wt. % or less, such as 0.4 wt. % or less, such as 0.35 wt. % or less, such as 0.3 wt. % or less based on the weight of the core. The polystyrene may be present in an amount of 0 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more based on the weight of the core. In addition, it should be understood that the aforementioned weight percentages may also apply to the amount of the polystyrene based on the weight of the cement board. Further, it should be understood that the aforementioned weight percentages may also apply to the amount of the polystyrene based on the weight of the slurry when discussed in the context of the cement slurry in making the cement board.

While the above may be utilized, in one embodiment, any additives considered a combustible additive may be used in a limited amount. In this regard, the combustible additives may be present in an amount of 1 wt. % or less, such as 0.8 wt. % or less, such as 0.6 wt. % or less, such as 0.5 wt. % or less, such as 0.45 wt. % or less, such as 0.44 wt. % or less, such as 0.4 wt. % or less, such as 0.35 wt. % or less, such as 0.3 wt. % or less based on the weight of the core. The combustible additives may be present in an amount of 0 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more based on the weight of the core. In addition, it should be understood that the aforementioned weight percentages may also apply to the amount of the combustible additives based on the weight of the cement board. Further, it should be understood that the aforementioned weight percentages may also apply to the amount of the combustible additives based on the weight of the slurry when discussed in the context of the cement slurry in making the cement board. In addition, in one embodiment, the aforementioned percentages may apply to the total amount of combustible additives. In another embodiment, the aforementioned percentages may apply to a particular species of combustible additives.

The cement core may also include a chemical set admixture. For instance, the chemical set admixture may be utilized to alter the hydration or properties of the slurry. For instance, such admixture may include a retarder, an accelerator, and the like, or a mixture thereof. In one embodiment, the admixture may include at least a retarder. In another embodiment, the admixture may include at least an accelerator.

In general, the chemical set admixture may include, but is not limited to, lithium salts (e.g., lithium carbonate), sodium tripolyphosphate, alkanolamines (e.g., triethanolamine), nitrites (e.g., calcium nitrite, sodium nitrite, etc.) calcium formate, sulfates (e.g., aluminum sulfate, sodium sulfate, calcium sulfate), sodium carbonate, calcium chloride, silicates (e.g., magnesium fluorosilicate, sodium silicate), calcium hydroxide, calcium-aluminate cement, boric acid, borax, formic acid, citric acid, sodium citrate, sodium gluconate, glucose, sucrose, fructose, or a mixture thereof. In one embodiment, the admixture may include a nitrite. In another embodiment, the admixture may include a sulfate. In a further embodiment, the admixture may include citric acid. In an even further embodiment, the admixture may include a sodium citrate. In one embodiment, the admixture includes at least two, such as at least three, such as at least four components.

In general, the chemical set admixture(s) may be present in the core in an amount of 0 wt. % or more, such as 0.0001 wt. % or more, such as 0.001 wt. % or more, such as 0.01 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the core. The chemical set admixture(s) may be present in the core in an amount of 20 wt. % or less, such as 15 wt. % or less, such as 13 wt. % or less, such as 10 wt. % or less, such as 9 wt. % or less, such as 8 wt. % or less, such as 6 wt. % or less, such as 5 wt. % or less, such as 4 wt. % or less, such as 3 wt. % or less, such as 2.5 wt. % or less, such as 2 wt. % or less, such as 1.5 wt. % or less, such as 1 wt. % or less, such as 0.5 wt. % or less, such as 0.3 wt. % or less, such as 0.1 wt. % or less based on the weight of the core. In addition, it should be understood that the aforementioned weight percentages may also apply to the amount of the chemical set admixture(s) based on the weight of the cement board. Further, it should be understood that the aforementioned weight percentages may also apply to the amount of the chemical set admixture(s) based on the weight of the slurry when discussed in the context of the cement slurry in making the cement board. In addition, the aforementioned percentages may also apply to a particular species within the chemical set admixture.

The cement core may also include a rheological admixture that serves as a rheology modifier and may also possibly serve as a strength enhancer. For instance, the rheological admixture may be utilized to reduce the water usage or alter the rheology of the slurry.

In general, the rheological admixture may include, but is not limited to, sulfonates (e.g., melamine sulfonate, sodium naphthalene sulfonate, lignosulfonates, etc.), polycarboxylate ethers, cellulose polymer derivatives (e.g., ethyl cellulose, hydroxypropyl methyl cellulose, hydroxyethyl cellulose, etc.), hydrophobically modified alkali swellable emulsions or hydrophobically modified ethoxylate urethanes, molecular rheology modifiers, polysaccharides (e.g., Wellan gum, xantham gum, etc.), galactomannans (e.g., guar gum, carob gum, etc.), and the like, or a mixture thereof. In one embodiment, the admixture may include a sulfonate. In another embodiment, the admixture may include a cellulose polymer derivative. In a further embodiment, the admixture may include a polysaccharide. In one embodiment, the admixture includes at least two, such as at least three, such as at least four components.

In general, the rheological admixture(s) may be present in the core in an amount of 0 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the core. The rheological admixture(s) may be present in the core in an amount of 10 wt. % or less, such as 8 wt. % or less, such as 6 wt. % or less, such as 6 wt. % or less, such as 5 wt. % or less, such as 4 wt. % or less, such as 3 wt. % or less, such as 2.5 wt. % or less, such as 2 wt. % or less, such as 1.75 wt. % or less, such as 1.5 wt. % or less, such as 1 wt. % or less, such as 0.8 wt. % or less based on the weight of the core. In addition, it should be understood that the aforementioned weight percentages may also apply to the amount of the rheological admixture(s) based on the weight of the cement board. Further, it should be understood that the aforementioned weight percentages may also apply to the amount of the rheological admixture(s) based on the weight of the slurry when discussed in the context of the cement slurry in making the cement board. In addition, the aforementioned percentages may also apply to a particular species within the rheological admixture.

The cement core may also include a surfactant. For instance, the surfactant may include those generally known in the art. In general, the surfactant may have a hydrophilic-lipophilic balance (HLB) value of 5 or more, such as 8 or more, such as 10 or more, such as 12 or more, such as 15 or more, such as 18 or more. The HLB value may be 25 or less, such as 20 or less, such as 18 or less, such as 15 or less, such as 13 or less, such as 10 or less.

The surfactant may include a nonionic surfactant, an anionic surfactant, a cationic surfactant, or a mixture thereof. In one embodiment, the surfactant may include at least an anionic surfactant. In another embodiment, the surfactant may include at least a nonionic surfactant. In a further embodiment, the surfactant may include at least a cationic surfactant. In one particular embodiment, the surfactant may include a combination of an anionic surfactant and a nonionic surfactant.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate, and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In one embodiment, the surfactant may include a cationic surfactant. For instance, the surfactant may include a cationic surfactant such as water-soluble quaternary ammonium compounds, polyammonium salts, a polyoxyethylene alkylamine, and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

In general, the surfactant(s) may be present in the core in an amount of 0 wt. % or more, such as 0.0001 wt. % or more, such as 0.0005 wt. % or more, such as 0.001 wt. % or more, such as 0.005 wt. % or more, such as 0.01 wt. % or more, such as 0.05 wt. % or more, such as 0.1 wt. % or more based on the weight of the core. The surfactant(s) may be present in the core in an amount of 5 wt. % or less, such as 4 wt. % or less, such as 3 wt. % or less, such as 2 wt. % or less, such as 1 wt. % or less, such as 0.8 wt. % or less, such as 0.5 wt. % or less, such as 0.3 wt. % or less, such as 0.2 wt. % or less, such as 0.15 wt. % or less, such as 0.1 wt. % or less, such as 0.08 wt. % or less, such as 0.05 wt. % or less, such as 0.03 wt. % or less, such as 0.01 wt. % or less, such as 0.005 wt. % or less, such as 0.001 wt. % or less based on the weight of the core. In one embodiment, a surfactant may not be utilized such that the weight percentage is 0. In addition, it should be understood that the aforementioned weight percentages may also apply to the amount of the surfactant(s) based on the weight of the cement board. Further, it should be understood that the aforementioned weight percentages may also apply to the amount of the surfactant(s) based on the weight of the slurry when discussed in the context of the cement slurry in making the cement board.

The cement core or slurry may also include a lime (e.g., calcium oxide) and/or dolomitic lime (e.g., CaMgO₂). The lime may be a hydrated lime, a quick lime, or a mixture thereof. In this regard, such may convert to calcium hydroxide. The lime may be present in the core in an amount of 0 wt. % or more, such as 0.1 wt. % or more, such as 0.2 wt. % or more, such as 0.5 wt. % or more, such as 1 wt. % or more, such as 1.5 wt. % or more, such as 2 wt. % or more, such as 2.5 wt. % or more, such as 3 wt. % or more, such as 5 wt. % or more based on the weight of the core. The lime may be present in the core in an amount of 10 wt. % or less, such as 8 wt. % or less, such as 6 wt. % or less, such as 6 wt. % or less, such as 5 wt. % or less, such as 4 wt. % or less, such as 3 wt. % or less, such as 2.5 wt. % or less, such as 2 wt. % or less, such as 1.75 wt. % or less, such as 1.5 wt. % or less, such as 1 wt. % or less, such as 0.8 wt. % or less based on the weight of the core. In addition, it should be understood that the aforementioned weight percentages may also apply to the amount of the lime based on the weight of the cement board. Further, it should be understood that the aforementioned weight percentages may also apply to the amount of the lime based on the weight of the slurry when discussed in the context of the cement slurry in making the cement board. In addition, the aforementioned percentages may also apply to the calcium hydroxide formed from the conversion of the calcium oxide.

The slurry utilized in making the cement board also includes water. Water may be employed for fluidity and also for hydration of the binders to allow for setting. The amount of water utilized is not necessarily limited by the present disclosure.

The water may be present in the slurry in an amount of 1 wt. % or more, such as 3 wt. % or more, such as 5 wt. % or more, such as 7 wt. % or more, such as 9 wt. % or more, such as 10 wt. % or more, such as 13 wt. % or more, such as 15 wt. % or more based on the weight of the slurry. The water may be present in the slurry in an amount of 40 wt. % or less, such as 30 wt. % or less, such as 25 wt. % or less, such as 20 wt. % or less, such as 15 wt. % or less, such as 10 wt. % or less based on the weight of the slurry.

For instance, the weight ratio of the water to the binders in the slurry may be 0.001 or more, such as 0.01 or more, such as 0.05 or more, such as 0.1 or more, such as 0.13 or more, such as 0.15 or more, such as 0.17 or more, such as 0.2 or more, such as 0.3 or more, such as 0.5 or more. The weight ratio of the water to the binders in the slurry may be 2 or less, such as 1.5 or less, such as 1.3 or less, such as 1 or less, such as 0.8 or less, such as 0.6 or less, such as 0.5 or less, such as 0.4 or less, such as 0.3 or less, such as 0.25 or less, such as 0.2 or less, such as 0.15 or less.

In some aspects, the weight ratio of the water to the solids in the slurry may be 0.001 or more, such as 0.01 or more, such as 0.05 or more, such as 0.1 or more, such as 0.13 or more, such as 0.15 or more, such as 0.17 or more, such as 0.2 or more, such as 0.3 or more, such as 0.5 or more. The weight ratio of the water to the solids in the slurry may be 2 or less, such as 1.5 or less, such as 1.3 or less, such as 1 or less, such as 0.8 or less, such as 0.6 or less, such as 0.5 or less, such as 0.4 or less, such as 0.3 or less, such as 0.25 or less, such as 0.2 or less, such as 0.15 or less.

In addition, the slurry may have a particular pH. For instance, the slurry may be basic or alkaline. In this regard, the pH may be more than 7, such as 8 or more, such as 9 or more, such as 10 or more, such as 11 or more, such as 11.5 or more, such as 12 or more, such as 12.5 or more. The pH may be 14 or less, such as 13.5 or less, such as 13 or less.

In addition to the binders and water, as well as other additives/components mentioned above, the slurry may also include any other conventional additives as known in the art. Accordingly, these conventional additives may also be present in the core and board. In this regard, such additives are not necessarily limited by the present disclosure. For instance, the additives may include dispersants, foam or foaming agents (e.g., ethoxylated alcohols; sulfonates such as alpha olefin sulfonates; etc.), biocides (such as bactericides and/or fungicides), adhesives, pH adjusters, leveling agents, non-leveling agents, starches (such as pregelatinized starch, non-pregelatinized starch, and/or an acid modified starch), natural or synthetic polymers, colorants, fillers, fire retardants, reinforcements (e.g., fibers, such as glass fibers), etc.

In general, it should be understood that the types and amounts of such additives are not necessarily limited by the present disclosure. When present, each additive may be present in the slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the core The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the core. In addition, it should be understood that the aforementioned weight percentages may also apply to the amount of the additive(s) based on the weight of the cement board. Further, it should be understood that the aforementioned weight percentages may also apply to the amount of the additive(s) based on the weight of the slurry when discussed in the context of the cement slurry in making the cement board.

With respect to the additives above, it should be understood that any one of such additives may not be present in the cement board, cement core, or slurry. In this regard, the wt. % may be 0 wt. %. In other embodiments, the cement board, cement core, or slurry may be substantially free of such additive. For instance, it may be present in an amount of 0.1 wt. % or less, such as 0.08 wt. % or less, such as 0.05 wt. % or less, such as 0.04 wt. % or less, such as 0.03 wt. % or less, such as 0.02 wt. % or less, such as 0.01 wt. % or less, such as 0.005 wt. % or less. Such aforementioned weight percentages may be based on the weight of the core. In addition, it should be understood that the aforementioned weight percentages may also apply to the amount of the additive(s) based on the weight of the cement board. Further, it should be understood that the aforementioned weight percentages may be based on the weight of the slurry when discussed in the context of the cement slurry in making the cement board.

For example, in one embodiment, the cement core (as well as the slurry used to make the cement core) may not include or may be substantially free of fibers, such as glass and/or synthetic fibers. In one embodiment, the cement core (as well as the slurry used to make the cement core) may not include or may be substantially free of slate, such as expanded slate or pumice. In a further embodiment, the cement core (as well as the slurry used to make the cement core) may not include or may be substantially free of a rheology modifier, such as a clay and/or a cellulose ether. In a further embodiment, the cement core (as well as the slurry used to make the cement core) may not include or may be substantially free of shale, such as expanded shale. In another further embodiment, the cement core (as well as the slurry used to make the cement core) may not include or may be substantially free of clay, such as expanded clay. In an even further embodiment, the cement core (as well as the slurry used to make the cement core) may not include or may be substantially free of perlite, such as expanded perlite.

In general, the core has a first surface and a second surface opposite the first surface. The cement board may also include a facing material, for example on a surface thereof. In this regard, the cement board may include any facing material as generally known in the art. In one embodiment, the facing material may be disposed directly on the surface. Also, in one embodiment, the facing material may be provided with an adhesive between the facing material and the core. In one embodiment, the facing material may be provided such that it is embedded at least to a certain degree within the core. Accordingly, for embedding the facing material, it may have openings sufficiently large to permit penetration of the slurry into and through the openings, which can permit bonding (e.g., mechanical bonding) of the facing material to the core. The facing material may be embedded at a depth such that it is not visible. However, the pattern it creates on a surface may be slightly visible. For instance, the facing material may be embedded at a depth of about 0.1 mm or more, such as 0.2 mm or more, such as 0.3 mm or more, such as 0.4 mm or more, such as 0.5 mm or more, such as 0.8 mm or more, such as 1 mm or more. The depth may be 5 mm or less, such as 4 mm or less, such as 3 mm or less, such as 2 mm or less, such as 1.5 mm or less, such as 1.3 mm or less, such as 1 mm or less, such as 0.8 mm or less, such as 0.6 mm or less, such as 0.5 mm or less, such as 0.4 mm or less. The facing material may be embedded by applying friction, vibration, or a combination of both, to the slurry such that it can assist in the creation of a strong bond between the facing material and the slurry.

The facing material as described herein may be any facing material as generally employed in the art. For instance, the facing material may be a paper or cellulosic facing material, a fibrous (e.g., glass fiber) mat facing material, a mesh facing material, a polymeric facing material, or a combination thereof. In one embodiment, the facing material is a mesh facing material. For instance, the mesh facing material may be a glass mesh facing material. In addition, the mesh facing material may be coated.

It should be understood that the facing materials employed in the cement board may be the same type of material. Alternatively, it should also be understood that the facing materials employed in the cement board may be of different types of materials.

In one embodiment, the facing material may be coated, using various materials as generally known in the art. In addition, such materials may also be considered combustible. Yet, even with their inclusion in the cement board as described herein, the cement board may nonetheless be rendered noncombustible in accordance with the tests as defined herein. The coating may include a polymer, such as a thermoplastic polymer. The polymer may include polyvinyl chloride, polyvinylidene chloride, etc., as well as copolymers thereof. However, it should be understood that other polymers may also be used for the coating.

The thickness of the facing material is not necessarily limited. For instance, the facing material may have a thickness of 0.01 mm or more, such as 0.05 mm or more, such as 0.1 mm or more, such as 0.2 mm or more, such as 0.25 mm or more, such as 0.3 mm or more, such as 0.5 mm or more, such as 1 mm or more, such as 2 mm or more, such as 3 mm or more, such as 5 mm or more, such as 7 mm or more, such as 9 mm or more, such as 10 mm or more. The facing material may have a thickness of 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, such as 0.8 mm or less, such as 0.6 mm or less, such as 0.5 mm or less, such as 0.4 mm or less, such as 0.3 mm or less, such as 0.2 mm or less.

In addition or alternatively, edge strips may be utilized as disclosed at least in U.S. Pat. No. 9,499,980, which is hereby incorporated by reference in its entirety. For instance, edge strips may generally have a U-shaped configuration and adhere to respective marginal areas. The edge strips may be adhered to the longitudinal edge face, merely abut the longitudinal edge face or be spaced apart from the longitudinal face. The edge strip may, for example, take on a U-shaped configuration as discussed herein. Alternatively, if desired, the longitudinal edge face or a part thereof may be open (i.e., not covered by an edge strip). In this latter case, one or both of the marginal areas adjacent a longitudinal edge on opposite broad or major faces may be provided with an edge reinforcing member.

The edge strips may be made of the same material as the facing materials disclosed therein. In one embodiment, the edge strips may be woven. For instance, the edge strips may be a mesh. In another embodiment, the edge strips may be non-woven. For instance, the edge strips may be a mat. The edge strips may be coated, such as using the coating materials mentioned herein with respect to the facing material. Regardless, examples of materials may include glass, steel, polyester, aramid resin, polyolefin, nylon fibers, polyvinylidene fluoride, polytetrafluoroethylene, cellulosics, and the like. In one particular embodiment, the material may be a polyester or a polyolefin. For example, the material may be a polyester (e.g., poly(ethylene terephthalate)). Alternatively, the material may be a polyolefin (e.g., polyethylene, polypropylene, etc.). Regardless, the edge strips may be made of a material allowing for relatively tight interstices such that it is generally impervious to the slurry.

The edge strips may be applied and bonded in any manner utilized in the art. For example, the edge strips may be applied utilizing an adhesive. Alternatively, the edge strips may be applied without utilizing an adhesive. For instance, the edge strips may simply adhere due to the cohesion between the slurry/core and the strips. In one embodiment, the edge strips may be applied such that they are on the exterior of the cement board. For example, they may be placed on the cement board after providing the facing materials.

Regardless of the configuration, after deposition of the slurry, the binder(s) reacts with the water to convert or set the binder(s). Such reaction may allow for the cement to set and become firm thereby allowing for the continuous sheet to be cut into cement boards at the desired length. In this regard, the method may comprise a step of reacting the binder(s) with water or allowing the binder(s) to convert or hydrate. In this regard, the method may allow for the slurry to set to form a continuous cement board sheet or a cement board.

The method may comprise a step of supplying the cement board or continuous cement board sheet to a heating device. For instance, such a heating device may be a kiln, an oven, or an autoclave and may allow for accelerating the hydration chemical reaction and or removal of any free water. It should be understood that this heating device may be different from the device used to heat a binder to form a first binder composition. The temperature and time required for heating in such a heating device are not necessarily limited by the present disclosure. Alternatively, the cement board may not enter into a heating device. Instead, the cement board may be allowed to undergo hydration/curing without requiring a heating device.

The method may also comprise a step of cutting a continuous cement board sheet into a cement board. In general, this may be conducted before or after exposing or providing the cement board or continuous cement board sheet to a heating device. For instance, in one embodiment, after the cutting step, the method may comprise a step of supplying the cement board to a heating device. In another embodiment, the method may comprise a step of cutting a continuous cement board sheet into a cement board after the heating step. In a further embodiment wherein a heating device is not utilized, the method may simply comprise a step of cutting a continuous cement board sheet into a cement board.

While the above generally discloses a method for making a cement board, it should be understood that such general method is disclosed in the art. For instance, general methods are disclosed at least in U.S. Pat. No. 9,499,980, which is hereby incorporated by reference in its entirety.

The thickness of the cement board, and in particular, the core, is not necessarily limited and may be from about 0.25 inches to about 1 inch. For instance, the thickness may be at least ¼ inches, such as at least 5/16 inches, such as at least ⅜ inches, such as at least 7/16 inches, such as at least ½ inches, such as at least ⅝ inches, such as at least ¾ inches, such as at least 1 inch, such as at least 1.5 inches, such as at least 2 inches. In this regard, the thickness may be about any one of the aforementioned values. For instance, the thickness may be about ¼ inches. Alternatively, the thickness may be about ⅜ inches. In one embodiment, the thickness may be about 7/16 inches. In another embodiment, the thickness may be about ½ inches. In a further embodiment, the thickness may be about ⅝ inches. In another embodiment, the thickness may be about ¾ inches. In another further embodiment, the thickness may be about 1 inch. With regard to the thickness, the term “about” may be defined as within 5%, such as within 4%, such as within 3%, such as within 2%, such as within 1%.

In addition, the weight of the cement board is not necessarily limited. For instance, the cement board may have a weight of 0.5 lbs/ft² or more, such as 1 lb/ft² or more, such as 1.3 lbs/ft² or more, such as 1.5 lbs/ft² or more, such as 1.8 lbs/ft² or more, such as 2 lbs/ft² or more, such as 2.3 lbs/ft² or more, such as 2.5 lbs/ft² or more, such as 2.8 lbs/ft² or more, such as 3 lbs/ft² or more, such as 3.3 lbs/ft² or more, such as 3.5 lbs/ft² or more, such as 3.8 lbs/ft² or more, such as 4 lbs/ft² or more. The weight may be 7 lbs/ft², such as 6 lbs/ft² or less, such as 5.5 lbs/ft² or less, such as 5 lbs/ft² or less, such as 4.8 lbs/ft² or less, such as 4.5 lbs/ft² or less, such as 4.3 lbs/ft² or less, such as 4 lbs/ft² or less, such as 3.8 lbs/ft² or less, such as 3.5 lbs/ft² or less, such as 3.3 lbs/ft² or less, such as 3 lbs/ft² or less, such as 2.8 lbs/ft² or less, such as 2.5 lbs/ft² or less. Such weight may be a dry weight, such as after the board leaves the heating device (e.g., kiln).

In addition, the density of the cement board is not necessarily limited. For instance, the cement board may have a density of 30 lbs/ft³ or more, such as 35 lbs/ft³ or more, such as 40 lbs/ft³ or more, such as 45 lbs/ft³ or more, such as 50 lbs/ft³ or more, such as 55 lbs/ft³ or more, such as 60 lbs/ft³ or more, such as 65 lbs/ft³ or more. The density may be 150 lbs/ft³ or less, such as 140 lbs/ft³ or less, such as 130 lbs/ft³ or less, such as 120 lbs/ft³ or less, such as 110 lbs/ft³ or less, such as 100 lbs/ft³ or less, such as 90 lbs/ft³ or less, such as 80 lbs/ft³ or less, such as 75 lbs/ft³ or less, such as 70 lbs/ft³ or less, such as 65 lbs/ft³ or less, such as 60 lbs/ft³ or less.

The cement board may have a certain fastener holding, which generally is a measure of the force required to pull a cement board off a wall by forcing a fastener head through the board. The values obtained from the fastener pull test generally indicate the maximum stress achieved while the fastener head penetrates through the board surface and core. In this regard, the cement board exhibits a fastener holding of at least about 30 lbf, such as at least about 40 lbf, such as at least about 50 lbf, such as at least about 60 lbf, such as at least about 70 lbf, such as at least about 80 lbf, such as at least about 85 lbf, such as at least about 90 lbf, such as at least about 95 lbf, such as at least about 100 lbf, such as at least about 110 lbf, such as at least about 120 lbf, such as at least about 130 lbf, as tested according to ASTM C473-19 or ASTM D1037. The fastener holding may be about 200 lbr or less, such as 180 lbf or less, such as about 150 lbf or less, such as about 140 lbf or less, such as about 130 lbf or less, such as about 120 lbf or less, such as about 110 lbf or less, such as about 105 lbf or less, such as about 100 lbf or less, such as about 95 lbf or less, such as about 90 lbr or less. Such fastener holding may be based upon the thickness and/or density of the cement board and/or the type of facing material and corresponding cohesive strength with the board's core. For instance, when conducting a test, such fastener holding values may vary depending on the thickness of the cement board. As an example, the fastener holding values above may be for a ⅝ inch cement board. However, it should be understood that instead of a ⅝ inch cement board, such fastener holding values may be for any other thickness cement board as mentioned herein. For instance, such fastener holding values may be for a ¼ inch cement board, a ½ cement board, a ¾ inch cement board, a 1 inch cement board, etc. In addition, such fastener holding values may be for a wet condition. Alternatively, such values may be for a dry condition. Further, such values may apply to both a wet and dry condition.

The cement board may have a certain compressive strength. For instance, the compressive strength may be about such as about 250 psi or more, such as about 500 psi or more, such as about 700 psi or more, such as about 900 psi or more, such as about 1,000 psi or more, such as about 1,100 psi or more, such as about 1,200 psi or more, such as about 1,250 psi or more, such as about 1,300 psi or more, such as about 1,500 psi or more as tested according to ASTM D2394. The compressive strength may be about 5,000 psi or less, such as about 4,000 psi or less, such as about 3,000 psi or less, such as about 2,500 psi or less, such as about 2,000 psi or less, such as about 1,800 psi or less, such as about 1,700 psi or less, such as about 1,600 psi or less, such as about 1,500 psi or less, such as about 1,400 psi or less, such as about 1,300 psi or less, such as about 1,250 psi or less. Such compressive strength may be based upon the thickness and/or density of the cement board. For instance, when conducting a test, such compressive strength values may vary depending on the thickness and/or density of the cement board. As an example, the compressive strength values above may be for a ⅝ inch cement board. However, it should be understood that instead of a ⅝ inch cement board, such compressive strength values may be for any other thickness cement board as mentioned herein. For instance, such compressive strength values may be for a ¼ inch cement board, a ½ cement board, a ¾ inch cement board, a 1 inch cement board, etc.

The cement board may have a certain flexural strength. For instance, the flexural strength may be about such as about 250 psi or more, such as about 350 psi or more, such as about 400 psi or more, such as about 500 psi or more, such as about 600 psi or more, such as about 700 psi or more, such as about 750 psi or more, such as about 800 psi or more, such as about 1,000 psi or more as tested according to ASTM C₉₄₇ which is prescribed by ASTM C₁₃₂₅. The flexural strength may be about 3,000 psi or less, such as about 2,500 psi or less, such as about 2,000 psi or less, 1,700 psi or less, such as about 1,500 psi or less, such as about 1,300 psi or less, such as about 1,100 psi or less, such as about 1,000 psi or less, such as about 900 psi or less, such as about 800 psi or less, such as about 750 psi or less, such as 650 psi or less. Such flexural strength may be based upon the thickness of the cement board, core density and/or reinforcement tensile strength. For instance, when conducting a test, such flexural strength values may vary depending on the thickness of the cement board. As an example, the flexural strength values above may be for a ⅝ inch cement board. However, it should be understood that instead of a ⅝ inch cement board, such flexural strength values may be for any other thickness cement board as mentioned herein. For instance, such flexural strength values may be for a ¼ inch cement board, a ½ cement board, a ¾ inch cement board, a 1 inch cement board, etc.

The cement board disclosed herein may have many applications. For instance, the cement board may be utilized for interior or exterior applications. The cement board may be used as a standalone board in construction for the preparation of walls, ceilings, floors, roofs, etc. In addition, it may be utilized in an environment that may generally be humid or wet, such as shower rooms, bathrooms, lock rooms, etc. In addition, it may be utilized in an area requiring high impact resistance and/or resistance to freezing and thawing. For example, it may be utilized as a substrate for a stucco wall system or a masonry veneer wall system. Once the board is affixed, as desired or necessary, another material may be affixed thereto such as, for example, ceramic tile, brick, marble panels, stucco, or the like. Reinforced cementitious panels or boards having cores formed of a cementitious composition with a surface being reinforced is demonstrated in U.S. Pat. Nos. 1,439,954, 3,284,980, 4,450,022, and 4,916,004, which are hereby incorporated by reference in their entirety. In addition, cement boards with reinforced edges are disclosed in U.S. Pat. No. 6,187,409, which is hereby incorporated by reference in its entirety.

### EXAMPLES

### Test Methods

Slump Test: The test is conducted by soaking a binder composition in water for 1 minute in a container. Then, the binder composition and the water are hand-mixed for 10 seconds. Next, the binder composition and the water, which may be referred to as a cement patty, are poured onto a glass plate from a height of 3 inches. The container was raised vertically with a smooth and uniform motion at a moderate (not rapid) speed, and the contents contained within the container were allowed to slump to a circular cement patty onto the surface of the glass plate. After the cement patty had solidified, the glass plate was turned over and the diameter of the slump in contact with the glass plate was measured to the nearest millimeter. In particular, the average of two measurements was reported, where the measurements are taken at right angles to each other.

### Example 1

Cement patties were made that included 100 grams of CEM I Portland Cement binder and 50 cc of water. The ratio of water to binder in the cement patties was 0.5. For Control Samples 1 and 2, no coating composition was applied or mixed with the binder.

For Samples 1-2, the coating composition was not applied to the binder and was instead mixed in with the binder and the water in a container. For Samples 1-2, dextrose was mixed with the water and the binder until the respective wt. % based on the weight of the binder of the dextrose stated in Table 1 was achieved. For instance, for Sample 1, dextrose was added until the amount of dextrose added to the mixture was 0.3 wt. % based on the weight of the binder in the cement patty.

Notably, for Samples 3-5, the binder used to form the cement patties had a coating composition applied thereon. The coating compositions were applied to the binder when the binder had a temperature of 250° F. The coating compositions had a temperature from about 60° F. to about 70° F. The temperature of the binder was determined by an infrared thermometer.

For Samples 3-5, a 20% solution of dextrose was applied to the binder until the respective wt. % based on the weight of the binder of the dextrose stated in Table 2 was achieved. For instance, for Sample 3, a 20% solution of dextrose was applied to the binder until the amount of dextrose applied was 0.3 wt. % based on the weight of the binder in the cement patty.

Tables 1 and 2 display the slump, which was tested in accordance with the above test method. Notably, the results of Table 1 and Table 2, and particularly the difference between Sample 1 and Sample 3, demonstrate that the application of the coating composition to a binder may advantageously provide enhanced fluidity to a cement patty as compared to the mixing of the coating composition with a binder and as compared to the exclusion of the coating composition.

TABLE 1

| | Control | | |
|---|---|---|---|
| | Sample 1 | Sample 1 | Sample 2 |
| CEM-1 [grams] | 100 | 100 | 100 |
| Water [cc] | 50 | 50 | 50 |
| Dextrose | 0 | 0.3 | 0.4 |
| [wt. %] | | | |
| Water to | 0.5 | 0.5 | 0.5 |
| Binder Ratio | | | |
| Slump [mm] | 105 | 127 | 125 |

TABLE 2

| | Control | | | |
|---|---|---|---|---|
| | Sample 2 | Sample 3 | Sample 4 | Sample 5 |
| CEM-1 [grams] | 100 | 100 | 100 | 100 |
| Water [cc] | 50 | 50 | 50 | 50 |
| Dextrose | 0 | 0.3 | 0.4 | 0.5 |
| [wt. %] | | | | |
| Water to | 0.5 | 0.5 | 0.5 | 0.5 |
| Binder Ratio | | | | |
| Slump [mm] | 105 | 143 | 130 | 135 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A method for making a binder composition comprising:
subjecting a binder to a thermal treatment to form a first binder composition; and
applying a coating composition to the first binder composition to form a second binder composition, the coating composition comprising water and a coating additive, the first binder composition having a temperature of about 70° C. or more when the coating composition is initially applied to the first binder composition.

2. The method of claim 1, wherein the binder comprises a cement, the cement comprising Portland cement, magnesia cement, alumina cement, calcium sulphoaluminate cement, slag cement, super sulfate cement, or a mixture thereof.

3. The method of claim 2, wherein the binder comprises fine calcium carbonate.

4. The method of claim 1, wherein the binder comprises a pozzolan material, the pozzolan material comprising blast furnace slag, metakaolin, silica fume, microsilica, fly ash, or a mixture thereof.

5. The method of claim 1, wherein the coating additive comprises a carbohydrate.

6. The method of claim 1, wherein the coating additive comprises a sugar.

7. The method of claim 1, wherein the coating additive comprises dextrose.

8. The method of claim 1, wherein the coating additive comprises a dispersant.

9. The method of claim 8, wherein the dispersant comprises a sulfonate.

10. The method of claim 8, wherein the dispersant comprises a carboxylate.

11. The method of claim 1, wherein the coating additive is present on the second binder composition in an amount of about 0.01 wt. % to about 5 wt. % based on the weight of the binder of the second binder composition.

12. The method of claim 1, wherein the first binder composition has a temperature of about 80° C. or more when the coating composition is initially applied to the first binder composition.

13. The method of claim 1, wherein the first binder composition has a temperature of about 100° C. or more when the coating composition is initially applied to the first binder composition.

14. The method of claim 1, wherein the first binder composition has a temperature of about 800° C. or less when the coating composition is initially applied to the first binder composition.

15. The method of claim 1, wherein the first binder composition has a temperature of about 200° C. or less when the coating composition is initially applied to the first binder composition.

16. The method of claim 1, wherein the coating formed from the coating composition covers about 0.1% or more of the surface area of the binder of the second binder composition.

17. The method of claim 1, wherein the method further comprises conditioning the second binder composition.

18. The method of claim 1, wherein the method further comprises applying a second coating composition to the second binder composition.

19. The method of claim 1, wherein the method further comprises heating and/or reheating the first binder composition before the coating composition is applied to the first binder composition.

20. The method of claim 1, wherein the coating composition is in the form of an emulsion.

21. The method of claim 1, wherein the coating composition is in the form of a dispersion.

22. The method of claim 1, wherein:
the binder comprises a cement; and
the first binder composition has a temperature of about 400° C. or less when the coating composition is initially applied to the first binder composition.

23. The method of claim 22, wherein at least a portion of the coating composition vaporizes after contacting the first binder composition.

24. The method of claim 23, wherein 10 wt. % or more of the coating composition vaporizes after contacting the first binder composition.

25. The method of claim 22, wherein the coating additive is present on the second binder composition in an amount of about 0.01 wt. % to about 5 wt. % based on the weight of the binder of the second binder composition.

26. A method of making a cement board comprising:
providing a first facing material;
depositing a cement slurry comprising the second binder composition of claim 1 and water onto the first facing material; and
providing a second facing material on the cement slurry.

27. The method of claim 26, wherein the weight ratio of the water to the total amount of binders in the cement slurry is about 0.8 or less.

28. A product comprising the second binder composition formed by the method of claim 1.
